(19) United States
(12) Patent Application Publication
(10) Pub. No.: US 2014/0185812 A1
(43) Pub. Date: Jul. 3, 2014

(54) Method for Generating a Surround Audio Signal From a Mono/Stereo Audio Signal

(71) Applicants: Tom Van Achte, Geel (BE); Franky Le Moine, Lichtaart (BE)

(72) Inventors: Tom Van Achte, Geel (BE); Franky Le Moine, Lichtaart (BE)

(73) Assignees: Tom Van Achte, Geel (BE); Uri Dardikman, Antwerpen (BE); Franky Le Moine, Lichtaart (BE)

(21) Appl. No.: 14/123,208

(22) PCT Filed: Apr. 5, 2012
(86) PCT No.: PCT/EP2012/001457

§ 371 Date: Feb. 28, 2014

(30) Foreign Application Priority Data
Jun. 1, 2011 (EP) 11168388.4

(51) Int. Cl. H04S 5/02

(52) U.S. Cl. CPC H04S 5/02
USPC 381/18

(57) ABSTRACT

Disclosed is a method for generating a surround-channel audio signal (Mout) from a mono/stereo audio signal (Min, Sin), comprising the steps of: a) generating a first multi-channel signal (M1) by surround panning the mono/stereo audio signal (Sin); b) generating a second multi-channel signal (M2) by effect processing the mono/stereo input signal (Min, Sin) so that the rear signals comprise at least reverberation of the mono/stereo audio signals; and c) mixing the corresponding signals of the first multi-channel signal (M1) and the second multi-channel signal (M2), thereby forming the surround-channel audio signal (Mout).

### TECHNICAL FIELD

The invention relates to a method for generating a surround-channel audio signal from a mono/stereo audio signal, in particular the generation of a 5.1 surround audio signal from a stereo audio signal.

### DEFINITIONS

Provided below is a list of conventional terms. For each of the terms below a short definition is provided in accordance with each of the term's conventional meaning in the art. The terms provided below are known in the art and the following definitions are provided for convenience purposes. Accordingly, unless stated otherwise, the definitions below shall not be binding and the following terms should be construed in accordance with their usual and acceptable meaning in the art.

Reverberation (filter): A linear or non-linear filter adapted to create a simulation of acoustic behavior within a (certain) surrounding space, typically, but not necessarily, including simulation of reflections from walls and objects. Some kinds of reverberation filters may implement convolution of the input signal or preprocessed derivative of the input signal with pre-recorded impulse-response.

Phantom Image: The virtual sound-source generated in reproduction of stereo sound via two or more loudspeakers. A phantom image may be located in front or behind a listener.

Surround Image: The totality of phantom images in surround reproduction, including images from behind the listener.

Panning: The act or process of manipulating some parameters of the signal, such as the relative amplitudes of the channels or their relative phase or delays.

Sweet-Spot: The area of best head position, in which listening to stereo or surround reproduction via loudspeakers is considered to be optimal and where the stereo/surround effect is well perceived.

Haas effect: Haas found that humans localize sound sources in the direction of the first arriving sound despite the presence of a single reflection from a different direction. A single auditory event is perceived. A reflection arriving later than 1 ms after the direct sound increases the perceived level and spaciousness (more precisely the perceived width of the sound source). A single reflection arriving within 5 to 30 ms can be up to 10 dB louder than the direct sound without being perceived as a secondary auditory event (echo). For the purpose of this patent application, with “Haas effect” is meant the effect that the first arrival of sound from the source determines perceived localization, whereas the slightly later sound from delayed loudspeakers simply increases the perceived sound level without negatively affecting localization.

### BACKGROUND ART

Surround-channel audio systems are known in the art, e.g. from movie theatres or home cinema systems, whereby a plurality of speakers are used to simulate a sound field surrounding the listener (or viewer). One of the most popular surround-audio configurations nowadays is the well known 5.1 speaker configuration illustrated in FIG. 4, whereby five full bandwidth speakers are located on a circle. The ideal listening position (also called sweet spot) is a small area located in the centre of the circle. The optional subwoofer for reproducing the low frequency effect (LFE) channel may be located anywhere in the room. FIG. 6 illustrates a more practical situation for most home users, whereby the left and right front and rear speakers are located in the corners of the room, and the centre speaker is located in the middle of the front wall. Again, the position of the subwoofer (if present) is not important for the quality of the surround audio image.

The main provider of surround audio content is probably the film industry. Although usually multiple audio streams are recorded during the production of a movie, the audio to be reproduced on every individual speaker may or may not be individually provided, e.g. on a DVD. Mainly due to bandwidth and storage capacity limitations, the original audio signals are typically compressed (e.g. using the well known Dolby AC3 encoding/decoding algorithm), or alternatively the multiple audio-streams may be encoded as two signals that fit in existing stereo channels. These two encoded signals then contain information about all audio channels, thus including the front and surround speakers. A well known matrix-encoding algorithm for this purpose is the Dolby Pro Logic® algorithm. A home theatre system having a corresponding decoder can then convert the two incoming signals back into multiple audio signals to be played on the individual speakers. An example is a 5:2:5 system, whereby the source material (e.g. during authoring at the studio) consists of five audio streams, which are matrix-encoded and stored (or transmitted) as two signals, and then converted back into five audio streams for playback on individual speakers (e.g. in the home). However useful these systems may be for the movie industry, they are not ideal for providing the most optimal music content.

The most popular format for storing high quality music is still the red book audio-CD, and many consumers have large collections of them. When such stereo audio content would be applied to the above described decoder systems, the audio streams would be falsely considered as encoded signals containing surround information for all the surround channels (which is not the case). Some clever decoder systems may detect that the signals are not encoded and may decide to switch to play only stereo content. Other not-so-clever systems decode and reproduce the decoded signal anyway, but the perceived quality of the sound is inferior to that of the stereo audio content that would be reproduced on classical stereo devices. This demonstrates that not just any sound reproduced by a surround speaker system is an improvement of the stereo listening experience.

### DISCLOSURE OF THE INVENTION

It is an object of the present invention to provide a new method that allows converting a mono/stereo audio signal comprising music content into a surround-channel audio signal with an improved audio surround image according to human perception.

This aim can be achieved according to the present invention with the method of the first claim. Thereto the invention provides a method for generating a surround-channel audio signal comprising at least two front signals and at least two rear signals from a source signal, the source signal being a mono audio signal comprising a single input signal or a stereo audio signal comprising a left and a right input signal, the method comprising the steps of:

a) generating a first multi-channel signal comprising left and right first front signals and left and right first rear signals by surround panning the mono/stereo audio signal in such a way that the mono/stereo signal is substantially equally spread over the first front and first rear signals;

b) generating a second multi-channel signal from the mono/stereo audio signal comprising left and right second front signals and left and right second rear signals by effect processing the mono/stereo input signal, so that the left and right second rear signals comprise at least reverberation of the mono/stereo audio signals;

c) mixing the corresponding signals of the first multi-channel signal and the second multi-channel signal in a predetermined ratio, wherein the first multi-channel signal is a main component and the second multi-channel signal is a secondary component.

In the context of the present invention, the terms “track” is used as synonym for “song” or a single piece of music.

By surround panning, a first surround signal is generated wherein the energy that was present in the incoming mono or stereo signal is distributed over the front and rear signals, to be reproduced on corresponding front and rear speakers. This gives a spatial impression of the surround sound image. By providing substantially synchronous front and rear signals without introducing substantial phase difference and/or delay, the human brain gets the impression that the sound sources are located closer to the middle of the room (e.g. close to the left and right wall, between the front speakers and the rear speakers), because of the Haas effect. In this way a further widening of the stereo content towards the back of the room is achieved.

By generating a second multi-channel signal comprising rear signals having reverberation of the mono/stereo signals, the spatial effect of the sound image is enhanced.

By mixing the first and the second multi-channel audio signals in a predefined ratio, the inventor surprisingly found that a surround channel audio signal can be created that provides a sound image completely different from either of the first and the second multi-channel signals (the panned signal, or the effect-signal). In particular the method of the present invention succeeds in creating a surround sound image that sounds very natural and realistic, also in the rear speakers (not only the front speakers).

In addition, by using a main component having a substantially equal spread of the mono/stereo signals over the front and rear signals, and by adding thereto effects such as reverb, subtle differences between the individual signals are created. The human hearing system will concentrate on these subtle differences, and perceives them as enjoyable audible effects, which is found remarkably enjoyable for music content.

Another advantage of the method of the present invention is that it provides an enlarged sweet spot, which results mainly from the surround panning. As a result, this method is much more forgiving in case of poor/inferior speaker placement and poor room acoustics in the listening environment.

Preferably the reverb has a noticeable duration of 1-30 ms. Adding reverb enhances the spatial effect of the surround audio image to simulate the impression of a large room or concert hall. However, too much reverb would mask the dynamics of the audio content present in the stereo signal. Reverb duration no longer than 30 ms is found very suitable for most music content.

With substantially equal surround panning is meant that a listener perceives little or no difference in the energy levels of the front and rear signals. In order to achieve this, preferably the surround panning is applied such that 40-60% of the energy of the first multi-channel signal is located in the first rear signals, preferably 45-55%, more preferably 45-50%. The inventor has found that by choosing these criteria, the stereo signal is substantially placed halfway between the front and the back of the room to get a wider stereo image. The reason for placing the image preferably slightly more to the front is because the human hearing system seems to be slightly more sensitive to sound coming from the back as compared to sound coming from the front. By distributing the energy slightly more to the front, this sensitivity difference is more or less compensated for, so that the surround panned signal seems equally loud from all directions according to human perception.

In an embodiment the surround panning is achieved according to a matrix multiplication with real coefficients and the source signals. Surround panning may be achieved in an elegant way by multiplying the input signals with a matrix having real coefficients (i.e. complex numbers with no imaginary part).

In an embodiment the effect processing is achieved according to a matrix multiplication with complex coefficients having non-zero imaginary parts, and the source signals. Although up-mixing of N to M (e.g. 2 to 5) signals using matrix up-mixing are know techniques in the film-industry for extracting surround information from pre-encoded stereo signals such as e.g. Dolby® encoded signals, these techniques may create considerable artefacts when applied to un-encoded music signals such as e.g. found on red book audio-CD's. However, when such an up-mixed signal of unencoded stereo data is mixed with a surround panned audio signal as described above, the inventor surprisingly found that the annoying artefacts in fact became enjoyable audio enhancements of the surround panned signal, which the brain may interpret as localised instruments.

Preferably the mixing of the first and second multi-channel signal in step c) comprises 60-95% of the first multi-channel signal, preferably 70-90%, more preferably approximately 80%, the remaining part being the second multi-channel signal. The combination of the first and second multi-channel signals in such a proportion was found to give the best (subjective) quality by a group of test-people.

Preferably the surround-channel audio signal is selected from the group of a 4.0 signal, a 5.0 signal, a 5.1 signal, a 7.0 signal and a 7.1 signal. The invention is especially concerned to provide optimal enjoyable subjective music quality for surround systems having at least four speakers, preferably five, in particular home and car surround systems.

Preferably the method further comprises step d) preceding the steps a) and b), wherein the loudness of the stereo audio signal is adapted for obtaining a predefined dynamic range and maximum peak level. This additional step makes the method more suitable, and the resulting subjective quality more predictable for a large range of source material without having to fine-tune all kinds of settings. In particular, as will be described further, it allows a constant (optimized) set of parameters to be selected per music genre.

Preferably the method further comprises step e) following step c) wherein the loudness of the surround-channel audio signal is adapted for obtaining a predefined dynamic range and peak level. This additional step makes sure that the surround channel audio signal generated by the present invention has a substantially uniform dynamic range and loudness, so that, when playing different songs from different record labels, or when switching radio channels etc, the loudness level is substantially constant.

The invention also discloses an electronic system for performing this method.

The invention also discloses a computer program for performing this method on a computer system.

### BRIEF DESCRIPTION OF THE DRAWINGS

The invention will be further elucidated by means of the following description and the appended drawings, wherein like reference numerals refer to like elements in the various drawings. The drawings described are only schematic and the invention is not limited thereto. In the drawings, the size of some of the elements may be exaggerated and not drawn on scale for illustrative purposes.

FIG. 1 shows a speaker configuration for a traditional stereo system.

FIG. 2 shows a preferred speaker configuration for a quadraphonic surround system having four speakers.

FIG. 3 shows a preferred speaker configuration for a 5.0 surround system.

FIG. 4 shows a preferred speaker configuration for a 5.1 surround system.

FIG. 5 shows a practical speaker configuration for a 5.0 system in a typical living room or car environment.

FIG. 6 shows a practical speaker configuration for a 5.1 system in a typical living room environment.

FIG. 7 shows a block-diagram of a first embodiment of a system for implementing the method of the present invention.

FIGS. 8 and 9 show the result of surround panning a stereo signal into the first multi-channel signal of the present invention.

FIG. 8 shows the energy present in a stereo signal.

FIG. 9 shows an example of the energy present in the first multi-channel signal of the present invention after surround panning of the stereo signal of FIG. 8.

FIGS. 10 and 11 show the result of up-mixing and effect processing for adding effects such as reverb.

FIG. 10 is identical to FIG. 8, showing the energy present in the stereo signal.

FIG. 11 shows an example of the energy present in the second multi-channel signal after up-mixing and the addition of reverb.

FIG. 12 shows a subjective quality rating curve for the surround-channel audio signal generated by the method of the present invention according to a test group. The dashed line shows the subjective quality for optimised settings per music genre. The solid line shows the subjective quality for optimised settings per track.

FIG. 13 shows a block-diagram of a second embodiment of a system for implementing the method of the present invention.

FIG. 14 shows an example of a broadcast system using the method of the present invention in an encoder part of the system.

FIG. 15 shows an example of a system using the method of the present invention to convert an archive of stereo content into an archive of surround content.

FIG. 16 shows how the surround content made in FIG. 15 can be played on existing decoders.

FIG. 17 shows the method of the present invention including loudness adaptation of the stereo audio signal, and loudness adaptation of the surround-channel audio signal.

### DETAILED DESCRIPTION OF PREFERRED EMBODIMENTS

### References

1 stereo to surround encoder system
2 surround panning module
3 effect processor
4 first scaling element
5 adder
6 encoder
7 interleaver
8 transmitter
9 transmission medium
10 receiver
11 de-interleaver
12 Amplifier
13 storage of stereo content
14 second scaling element
15 Storage of surround content
16 loudness adaptation of the stereo signal
17 conversion of stereo to surround
18 sweet spot
19 loudness adaptation of the surround-channel signal
20 decoder
21 surround panning
22 effect addition
23 mixing
M1 first multi-channel signal
M2 second multi-channel signal
Mout surround channel audio signal
Sin stereo audio signal

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present invention, the only relevant components of the device are A and B.

In the present application, unless otherwise noted, the notation Lf is used for both the left front speaker and the left front audio signal intended to be reproduced by that speaker. The same applies for the other speakers and corresponding signals.

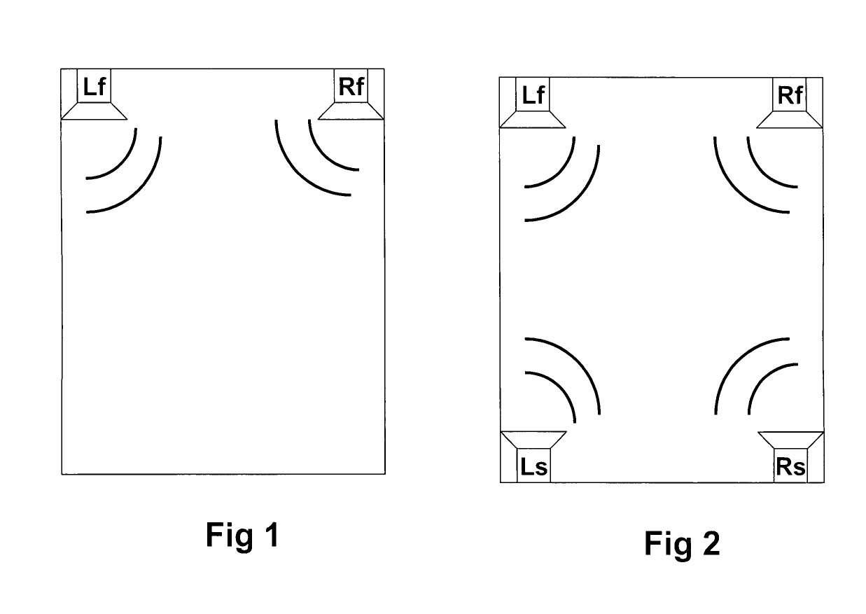

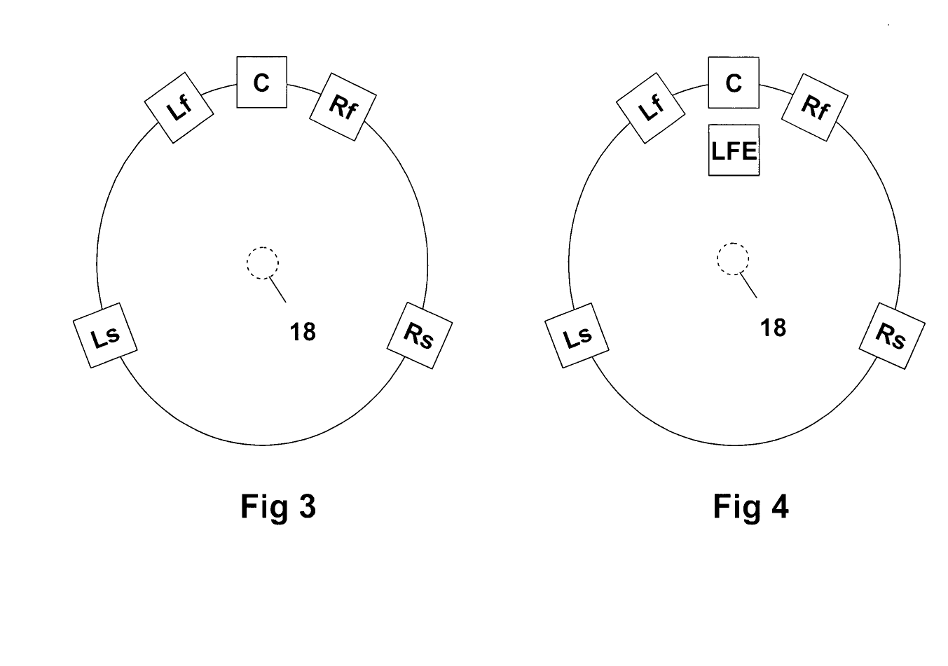

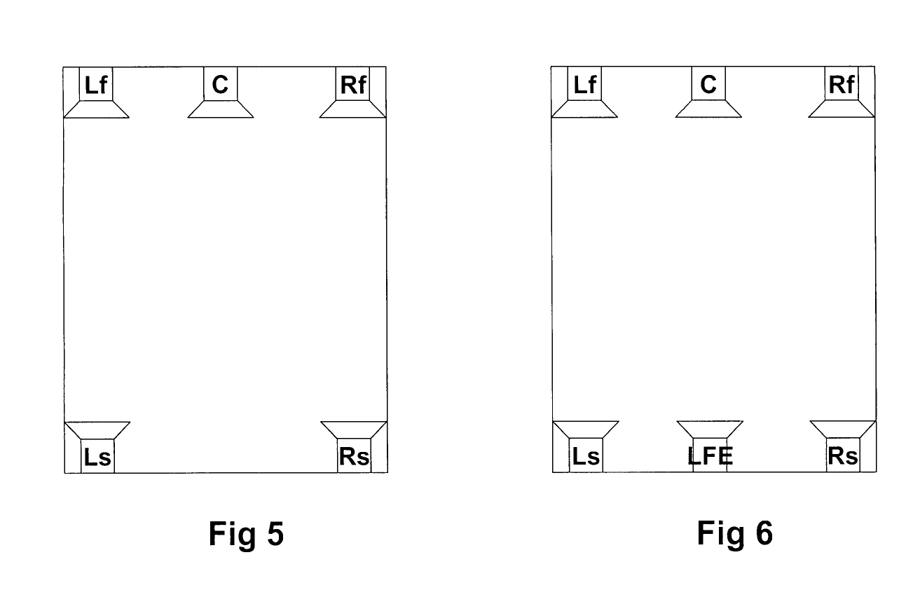

The present invention relates to a method for converting an un-encoded mono/stereo audio signal, e.g. a digital stereo audio file having a left and right data channel intended to be reproduced on a left and right speaker Lf, Rf of a stereo audio speaker system such as shown in FIG. 1, into a multiple-channel surround audio signal, e.g. a four-channel audio file having four data channels intended to be reproduced on four speakers Lf, Rf, Ls, Rs of a quadraphonic speaker system as shown in FIG. 2, or e.g. into a five-channel audio file having five data channels intended to be reproduced on five loudspeakers Lf, C, Rf, Ls, Rs of a 5.0 surround audio system as shown in FIG. 3 or 5, or e.g. into a six-channel audio file having six data channels intended to be reproduced on six speakers Lf, C, Rf, Ls, Rs, LFE of a 5.1 surround audio system as shown in FIG. 4 or 6, but the invention is not limited thereto, and can also be extended to multi-surround channel audio signals having more than 6 channels, e.g. to 7.0 or 7.1 surround audio signals, or even higher. The invention will be further illustrated by way of example as a method for converting a stereo audio signal into a 5.0 surround-channel audio signal, but can readily be adapted for other surround-channel audio signals. The principles described below can also be used for a mono audio input signal Min, e.g. by using the mono audio signal as the left and the right input signals Lin, Rin.

First some aspects of the speaker-configurations of the FIGS. 1 to 6 will be briefly discussed. FIG. 1 shows a traditional stereo loudspeaker configuration, having a left Lf and right Rf front speaker for reproducing respectively a left and right audio signal as recorded by two or more microphones, mixed into a stereo end result. Since the invention and the commercial availability of audio-CD's and audio-CD players (in the early 80'ies) a huge amount of music content has become available in digital stereo format. A way will be described to convert that music content into a surround audio signal that can be played on multi-surround audio systems, in an optimal enjoyable way.

FIG. 2 shows a quadraphonic speaker configuration having two front speakers Lf, Rf and two rear speakers Ls, Rs. In the past however, the four audio signals for these four speakers were recorded but not stored or transmitted as four discrete audio signals, but they were encoded (for storage or transmission) into two channels called “Left Total” and “Right Total”, typically abbreviated as Lt, Rt, using encoding matrices, such as e.g. the well known CBS SQ 2:4 matrix, having the following matrix coefficients:

| encoding matrix | Left Front | Right Front | Left Back | Right Back |
|---|---|---|---|---|
| Left Total | 1.0 | 0.0 | k 0.7 | 0.7 |
| Right Total | 0.0 | 1.0 | −0.7 | j 0.7 |

whereby j=+90° phase shift and k=−90° phase shift. During reproduction, the Left Total (Lt) and Right Total (Rt) signals were converted back into four discrete signals using appropriate decoding techniques. Note that these Left Total and Right Total signals are specially encoded signals for the purpose of being decoded by a quadraphonic decoder system. The encoding and decoding together is noted as 4:2:4 to indicate that four signals are encoded into two signals, which are later decoded back into four signals. Also other encoding matrices have been proposed in literature for the quadraphonic system.

The company Dolby® has proposed other encoding/decoding systems, also called down-mix/up-mix systems for 3, 4, 5 and more speakers. To name a few, Dolby Surround® is a 3:2:3 matrix encoding/decoding technique, wherein 3 audio signals (left, right, surround) are encoded into two signals according to the following matrix:

| Dolby Surround | Left Front | Right Front | Surround |
|---|---|---|---|
| Left Total | 1.0 | 0.0 | −j · √(1/2) |
| Right Total | 0.0 | 1.0 | j · √(1/2) |

Dolby Pro Logic® is a 4:2:4 matrix-encoding/decoding technique wherein four audio signals are encoded into two signals, using the following encoding matrix:

| Dolby Pro Logic | Left Front | Right Front | Center | Rear |
|---|---|---|---|---|
| Left Total | 1.0 | 0.0 | √(1/2) | −j · √(1/2) |
| Right Total | 0.0 | 1.0 | √(1/2) | j · √(1/2) |

Dolby Pro Logic II is a 5:2:5 matrix-encoding/decoding technique wherein five audio signals are encoded into two signals, using the following encoding matrix:

| | Left | Right | | Rear | Rear |
|---|---|---|---|---|---|
| Dolby Pro Logic II | Front | Front | Center | Left | Right |
| Left Total | 1.0 | 0.0 | √(1/2) | −j · √(19/25) | −j · √(6/25) |
| Right Total | 0.0 | 1.0 | √(1/2) | j · √(6/25) | j · √(19/25) |

FIG. 3 shows a preferred speaker configuration for a 5.0 surround system, which is the same as the configuration for a 5.1 system shown in FIG. 4, except for the absence of a subwoofer, the latter being used for reproducing low frequency effects (the so called LFE channel), comprising e.g. audio signals below 51 Hz, as typically encountered in movie scenes with earth quakes or explosions. The subwoofer can be placed anywhere in the room, because its low frequency sound does not show considerable delay in different listening positions of the room. The other speakers on the other hand have a preferred position, and are ideally located on a circle. The 5.0 configuration has become very popular for playing Dolby AC3 or Dolby Pro Logic encoded audio content stored on DVD disks. Dolby AC3 is a technique wherein multiple discrete signals are stored in a compressed way for the different speakers.

In the prior art, the audio content is encoded in such a way that the optimal listening position (sweet spot) is a small position in the middle of the circle, having a diameter of approximately 40 cm, and this is where the listener should optimally be sitting. In this spot the sounds of the different speakers come together in the intended mix.

FIGS. 5 and 6 show practical configurations for 5.0 and 5.1 surround systems as can be found in many living rooms or car environments whereby the front speakers Lf (left front), C (centre), Rf (right front) are placed at the front of the room, typically near or behind the television set, and the surround speakers (also called rear speakers) Ls (left surround), Rs (right surround) are placed in the back of the room, typically next to or behind the sofa. When reproducing a classical un-encoded stereo audio signal (e.g. on an audio-CD) using standard stereo equipment, only the Lf and Rf speakers are used. A method is described for converting that un-encoded stereo audio signal, in particular music, to a multiple-channel surround audio signal (or file) with discrete audio channels for the different speakers in such a way that the reproduced audio image provides a more enjoyable listening experience. Preferably that surround audio signal is formatted in a stream that can be played by existing equipment, e.g. a home computer with a hardware surround compatible soundcard and a “real 5.1” decoder software usually provided by the hardware manufacturer, or home theatre systems capable of playing “real 5.1” streams. An example of a software media player capable of playing a “real 5.1” stream is the Microsoft® Silverlight® media player. Home theatre systems capable of playing “real 5.1” streams are e.g. commercially available from Pioneer® or Hartman-Kardon®, just to name a few. The surround audio signal may be read from a local storage medium (e.g. a DVD, a HD-DVD, a Blu-Ray disk, a hard disk, etc), or may be streamed over a network (e.g. a cable network, satellite network, or any other network known to the person skilled in the art).

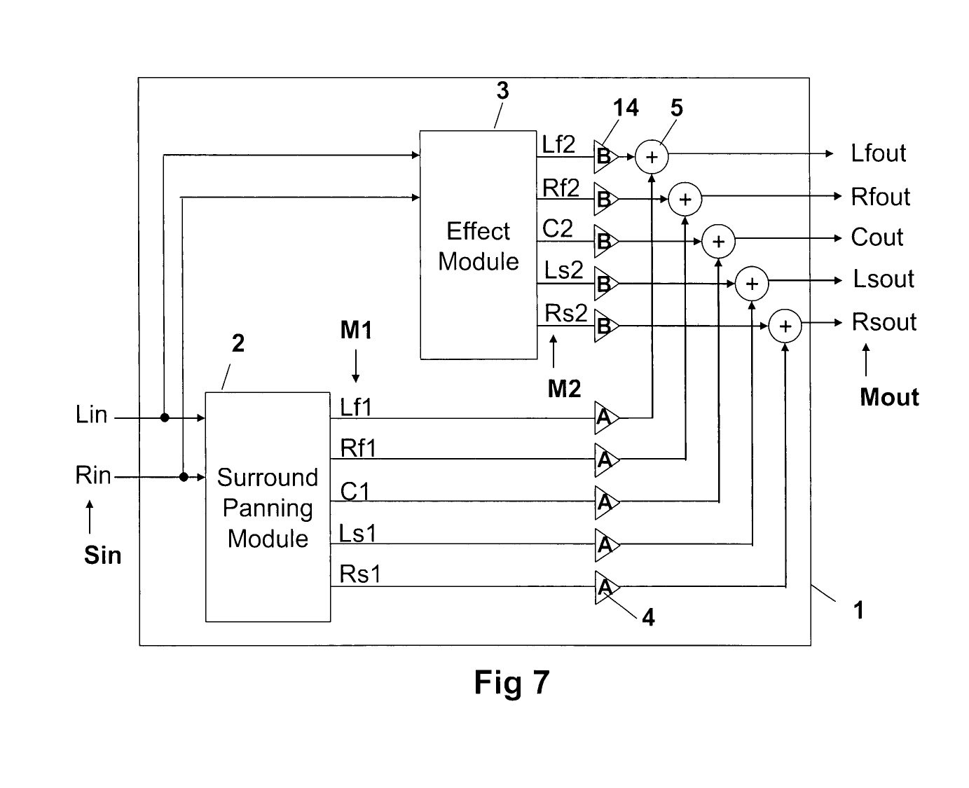

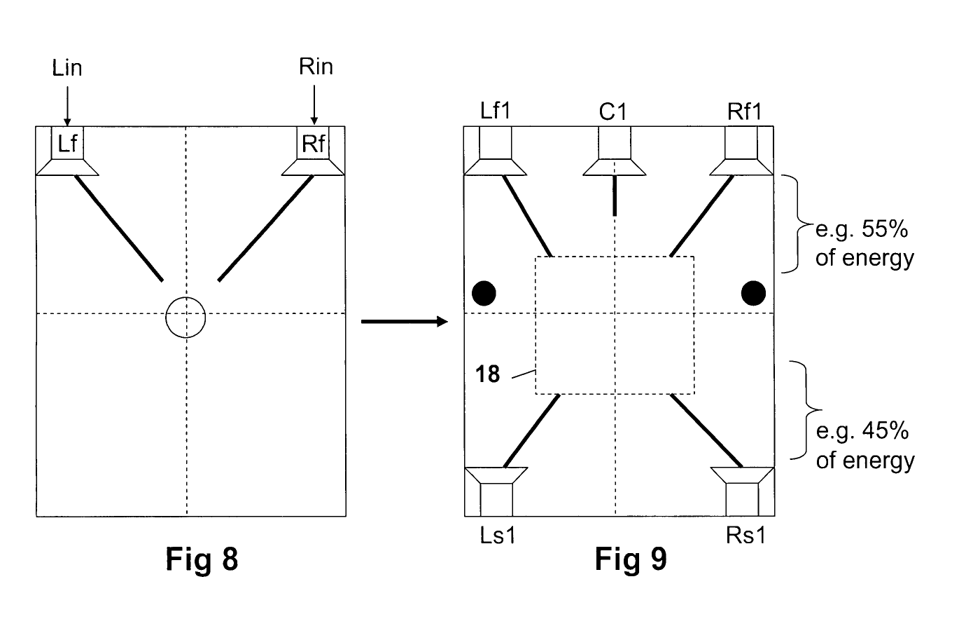

FIG. 7 shows a block-diagram of a first embodiment of a system 1 for converting a stereo audio signal Sin into a surround-channel audio signal Mout. The input of the system 1 is a traditional stereo audio signal (or file) Sin, consisting of a left audio signal Lin, and a right audio signal Rin. It is important to note that these signals Lin, Rin are unencoded signals, as opposed to the encoded Ltotal and Rtotal signals as described above. The stereo input signal Sin goes into a surround panner module 2, which generates a first multi-channel signal M1 therefrom by surround panning the stereo audio signal Sin in such a way that the mono/stereo signal is substantially equally spread over the first front signals Lf1, Rf1 and first rear signals Ls1, Rs1. The energy of the stereo audio signal Sin is preferably distributed over the first front channels Lf1, Rf1 and over the first rear channels Ls1, Rs1 in a way that leaves the left signal substantially located on the left, and the right signal substantially located on the right, and without introducing substantial phase shift or substantial delay. In an example, the left first front signal Lf1 and the left first rear signal Ls1 are attenuated versions of the left input signal Lin, and the right first front signal Rf1 and the right first rear signal Rs1 are attenuated versions of the right input signal Rin. The surround panning 21 will be further described in relation to FIGS. 8-9.

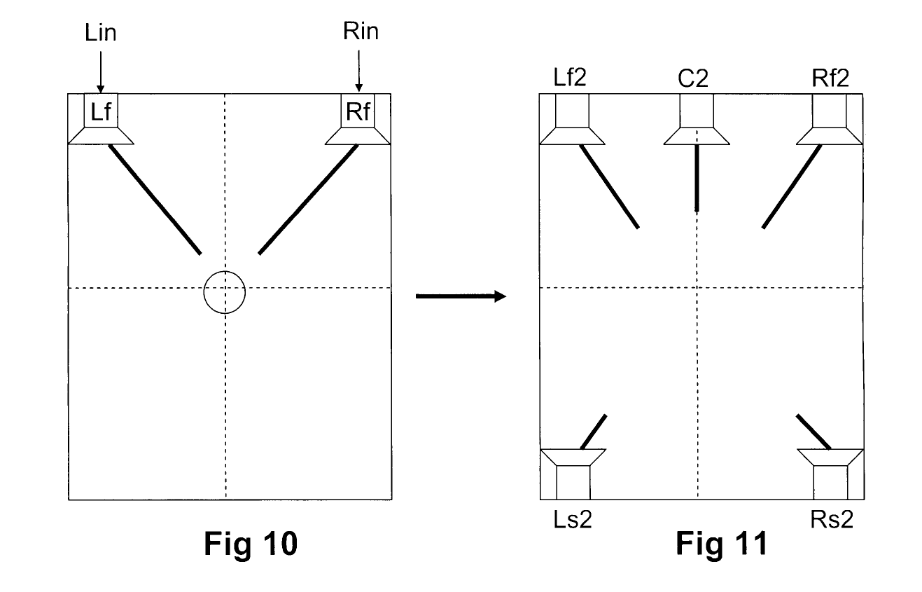

The stereo input signal Sin also goes into an effect processor 3, which generates a second multi-channel signal M2 therefrom, in such a way that the left and right second rear signals Ls2, Rs2 comprise at least reverberation of the stereo audio signals Lin, Rin. Different kinds of reverb exist, and they can be implemented in several different ways, e.g. using FIR filters (finite impulse response filter) or IIR filter (recursive filters), or any other way known by the person skilled in the art. The effect processing 22 will be further described in relation to FIGS. 10-11. In an example, the effect processor 3 first up-mixes the stereo input signal Sin by using a 2×5 matrix, or cascaded matrices, and then adds reverb to at least some of the up-mixed channels, preferably the rear channels.

The first and second multi-channel signals M1, M2 are then combined by mixing them in adjustable amounts to form the surround-channel audio signal Mout. The mixing may e.g. be implemented by scaling the individual signals Lf1, Rf1, C1, Ls1, Rs1 of the first multi-channel signal M1 by a first scaling factor A, e.g. 75%, and scaling the individual signals Lf2, Rf2, C2, Ls2, Rs2 of the second multi-channel signal M2 by a second scaling factor B, typically being equal to 1-A, e.g. 25%, and then summing the corresponding scaled first and second signals to form the output signal Mout comprising the discrete signals Lfout, Rfout, Cout, Lsout, Rsout. The inventor has surprisingly found that the surround sound image of the surround channel audio signal Mout sounds completely different than the sound-image created by the first multi-channel signal M1 when it is applied to the speakers, and also the sound-image created by the second multi-channel signal M2 when it is applied to the speakers. In particular, the combined signal Mout creates a surround sound image that sounds very spatial, vivid and natural, and is remarkably enjoyable for music content. The impact of the panning and the impact of the audible effects (e.g. reverb) can be selected by choosing proper scaling factors A and B. The ratio A/B should be chosen low enough to allow sufficient contribution of the effects, but should be high enough to prevent that the surround signal sounds too artificial. The inventor was very surprised to see that the audible “artefacts” of the second multi-channel signal M2 actually provide a very natural and enjoyable impression when mixed with the surround panned channels. The person skilled in the art will notice that the weighted mixing can also be achieved by using a single scaling factor on either M1 or M2 before adding them in the adder 5, optionally be applying additional scaling (volume control) at the output or further in the system (e.g. in the amplifier).

FIGS. 8 and 9 illustrate the effect of surround panning of the stereo input signal Sin, consisting of the signals Lin, Rin. In FIGS. 8-11 the length of the thick lines symbolically represent the amount of energy present in each individual signal. By spreading part of the energy of the Lf-signal to Lf1 and Ls1, and similar at the right, a kind of further widening of the stereo content to the back of the room is achieved, simulating the effect as if the musical instruments are more widely spread around the listener.

As a non-limiting example, in its simplest form, the panning may be seen as part of the energy of the left front speaker being moved to the left rear speaker, and part of the energy of the right front speaker being moved to the right rear speaker. Such a surround panning may e.g. be implemented by using the following set of equations:

Lf=0.5*Lin,

C=0,

Rf=0.5*Rin,

Ls=0.5*Lin,

Rs=0.5*Rin,

in which example the energy is spread in the same amount between the front and back signals. Moreover, in this case the left first front and rear signals Lf1, Ls1 are attenuated versions of the left input signal Lin, and the right first front and rear signals Rf1, Rs1 are attenuated versions of the right input signal Rin. Exact equal spreading is not required however, and the following set of equations is preferably used:

Lf=0.55*Lin,

C=0

Rf=0.55*Rin,

Ls=0.45*Lin,

Rs=0.45*Rin.

In this example, the energy is located slightly more in the front of the room, which may compensate for the fact that the human hearing system is slightly more sensitive for signals coming from the back, than for signals coming from the front.

Although available surround panner tools allow some mixing of the left signal Lin into the right channels Rf1, Rs1 and vice versa, this option is preferably not used in the surround panner 2, and also the addition of reverb, and/or the addition of delay is preferably not used in the surround panner module 2.

Whereas the centre channel C is heavily used in the film industry for locating most of the voice or dialogue information in the middle of the screen, this is less desirable for music content. The following set of equations would distribute 40% of the energy of the first multi-channel signal M1 in the left and right front speakers, 15% in the centre speaker, yielding a total of 55% in the front speakers, and 45% of the energy in the rear speakers:

Lf=0.40*Lin,

C=0.15*Lin+0.15*Rin

Rf=0.40*Rin,

Ls=0.45*Lin,

Rs=0.45*Rin.

This can also be obtained by applying matrix-multiplication, whereby the surround-channel audio signal M1=[Lf1, C1, Rf1, Ls1, Rs1]=M×[Lin, Rin], whereby the matrix M has the following real coefficients:

| | |
|---|---|
| 0.40 | 0 |
| 0.15 | 0.15 |
| 0 | 0.40 |
| 0.45 | 0 |
| 0 | 0.45 |

In software this may be implemented as a sum of products, e.g. in a DSP using a MAC-instruction. In hardware this can be implemented using analog or digital scalers and adders. As shown by the zero coefficients, the right input signal is preferably not mixed into the left speakers, and vice versa. Preferably the energy of the Centre speaker C is chosen from 0%-16%, preferably from 0%-12%, more preferably from 0%-8% of the total energy of the first multi-channel M1. Tests have shown that this value only has a small influence on the surround audio image, unless the value is too large (e.g. larger than 16%) which may disturb the energy balance between the three front speakers Lf, C, Rf and the two rear speakers Ls, Rs. The main result of distributing the energy between the front and rear speakers and by avoiding any substantial delay between the front and the back signals, is that the stereo signals Lin, Rin are no longer perceived as coming only from the front speakers, but from all the speakers, due to the Haas effect. When this energy is “moved” e.g. substantially halfway between the front and the back, the listener sitting in the middle of the room gets the impression that the room is filled with music coming from all the speakers. As will be explained next, minor differences between the channels (as will next be introduced by the Effect processor 3) will be detected by the human hearing system unconsciously, perceiving the sound as coming from the location of the first incident wave, according to the Haas effect. By adding different effects to each individual signal, the different effects seem to be coming from the different speakers.

Another effect of the surround panning is that the size of the sweet spot 18 is largely increased.

Referring back to FIG. 7, the inventor has found that it is important to keep the delay through the Surround Panning module 2 and the delay through the Effect processor 3 substantially equal, so that transients in the first and second multi-channel signals M1 and M2 substantially coincide when mixing them together. The person skilled in the art may need to add external delay next to one of the modules 2, 3 to achieve this, in case the internal delay of the Surround Panner 2 and the Effect processor 3 would be substantially different.

FIGS. 10 and 11 illustrate the result of the Effect processor 3. FIG. 10 is identical to FIG. 8, wherein the length of the thick lines symbolically represents the amount of energy present in the Lin and Rin signal. FIG. 11 shows the energy distribution in the second multi-channel signal M2, but the main purpose of the Effect processor 3 is not to distribute the energy, but to change the sound (also called ring) by adding effects, at least by the addition of reverb, optionally also by other kinds of filtering, such as equalisation, or other filtering techniques effects known by the person skilled in the art. The human brain will differentiate the different rings in the different sounds coming from the different speakers. Using four or more speakers, this effect can be more pronounced, and more gradations are possible than are known with stereo using two speakers.

As a non-limiting example of an Effect processor 3, the inventor has found that an up-mixing decoder module as described above in relation with 4:2:4 encoding/decoding systems, which is in fact intended to decode encoded stereo signals (Ltotal, Rtotal), may well be used for creating such effects by applying non-encoded stereo signals Lin, Rin. Such decoders typically place a lot of the signal energy in the front speakers, and send a filtered version with effects such as reverb to the rear speakers. It is important to note however, that if the output M2 of the effect processor 3 were to be reproduced alone (i.e. without mixing with the surround panned signal M1), the resulting surround audio image would sound completely different, either too much like the original stereo signal (in case not enough effect is introduced, also known as “too dry”), or too artificial (when too much effect is introduced, also known as “too wet”). The effect processor 3 is not limited however to existing decoder modules. Apart from reverb it may also comprise other effects, such as e.g. equalisation, band filtering, compression/decompression preferably with a sufficiently high compression ratio to cause audible artefacts, or other effect processing known by the person skilled in the art.

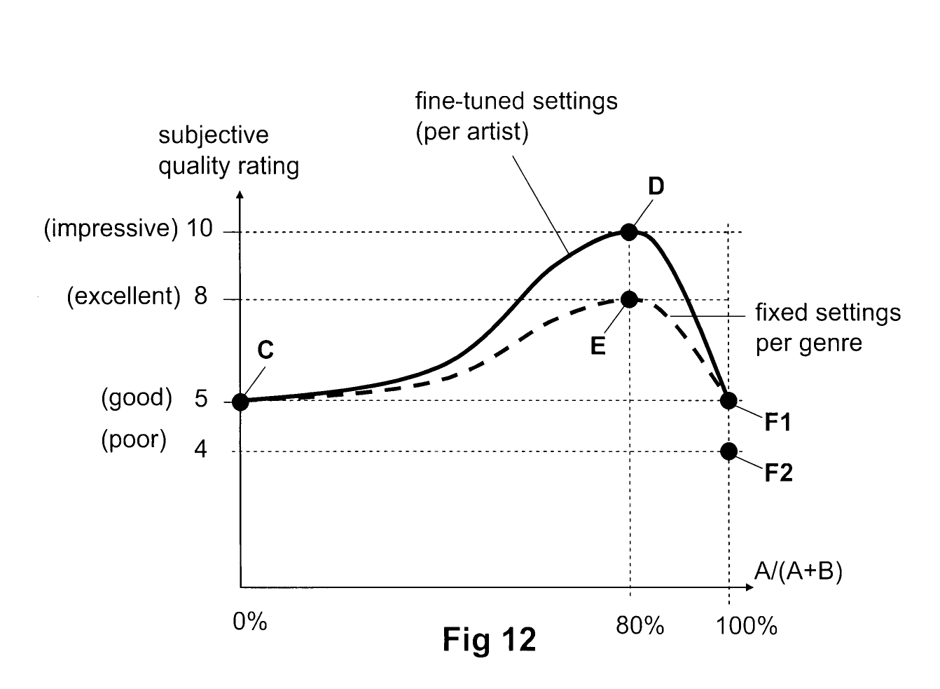

FIG. 12 shows a subjective quality rating curve for the surround-channel audio signal Mout using the surround panner module 2 and the effect processor 3 as described in the example below, which was used on a large set of audio-CD-tracks of different genres. Although not shown in FIG. 12, the surround sound image of the stereo signal Sin, (see FIG. 8) got a subjective quality rating of 5 (good), mainly because the sound image is only located in the front. Point C of FIG. 12 corresponds to the surround sound image of the M1 signal (only surround panning without effects), getting also a rating of 5 (good), due to the lack of effects, the sound image is merely shifted somewhat to the back of the room. Point F1 corresponds to the surround sound image of the M2 signal (only up-mix and little amount of effects without surround panning), also getting a subjective quality rating of 5 (good) because it resembles very much the surround sound image of the stereo signal (FIG. 8), with only a negligible improvement by the effects. Point F2 corresponds to the surround sound image of the M2 signal (only up-mix and too much effects, without surround panning), getting a subjective quality rating of 4 (poor) mainly because of too much effects which sound very artificial. Point E corresponds to a mix of 80% M1 (surround panning)+20% M2 (effects and reverb), using fixed (but optimised) settings per music genre, getting a subjective quality rating of 8 (excellent). Point F corresponds to a mix of 80% M1 (surround panning)+20% M2 (effects and reverb), using fine-tuned settings per track, getting a subjective quality rating of 10. The dashed line shows the estimated subjective quality for fixed (but optimised) settings per music genre in function of the mixing ratio A/B as explained above. The solid line shows the subjective quality rating for optimised settings per track, as fine-tuned by the mastering engineer, which, as can be seen from FIG. 12 yields a further sound quality improvement. For a given set of settings, optimal results are achieved by choosing the ratio A/B such that the mixing of the first and second multi-channel signal (M1, M2) in step c) comprises 60-95% of the first multi-channel signal (M1), preferably 70-90%, more preferably approximately 80%. The fact that the subjective audio quality is improved from 5 to 8 using fixed settings, clearly demonstrates that the method as described above offers a considerable improvement to the listening experience, even when using fixed settings per genre. Tests have shown that the settings need not be modified during a track.

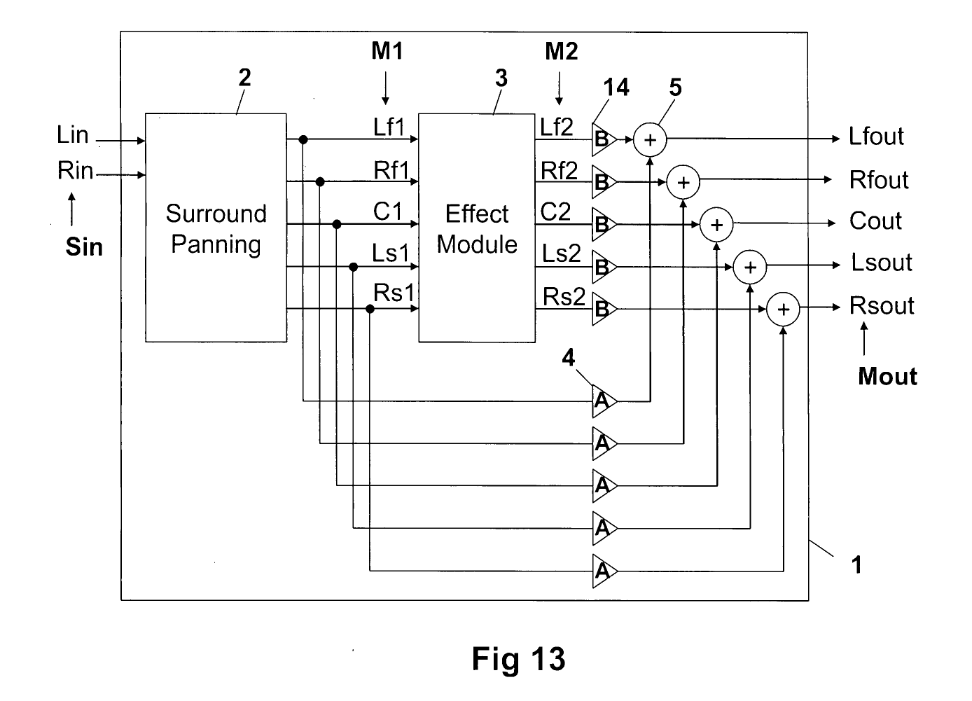

FIG. 13 shows a block-diagram of a second embodiment of a system 1 for implementing the method of converting a stereo audio signal Sin into a surround-channel audio signal Mout. The main difference with the block-diagram of the first embodiment of FIG. 7 is that the input of the Effect processor 3 is not directly derived from the stereo input signal Sin, but indirectly by using the first multi-channel signal M1 as input. Effects may be added thereto by adding reverb, and/or by using a 5×5 matrix with at least one complex coefficient having a non-zero part, and/or by equalisation, and/or other types of filtering. If the effect processor 3 in the system of FIG. 13 has a noticeable internal delay, the same delay should be added to the other (direct) path, e.g. before or after the scalers 4, so that the signals entering the adders 5 are substantially synchronous, as explained above.

The systems of FIG. 7 and FIG. 13 can be easily extended to e.g. a 7.0 system, whereby the surround panning distributes the energy substantially equally over the front, mid and rear speakers, e.g. each being allocated approximately 33% of the energy of the first multi-channel audio signal M1, and whereby the Effect processor 3 preferably creates audible differences between these signals. Similar to the examples above, in case a centre speaker C is used at the front, its energy would be added to that of the left and right front speakers Lf, Rf, the sum being in the range 33%+/−5%. Likewise, if a centre speaker would be used at the back, its energy would be added to that of the left and right rear speakers, the sum also being in the range 33%+/−5%. It is clear to the person skilled in the art that this principle can easily be extended to systems having more than seven signals (and speakers).

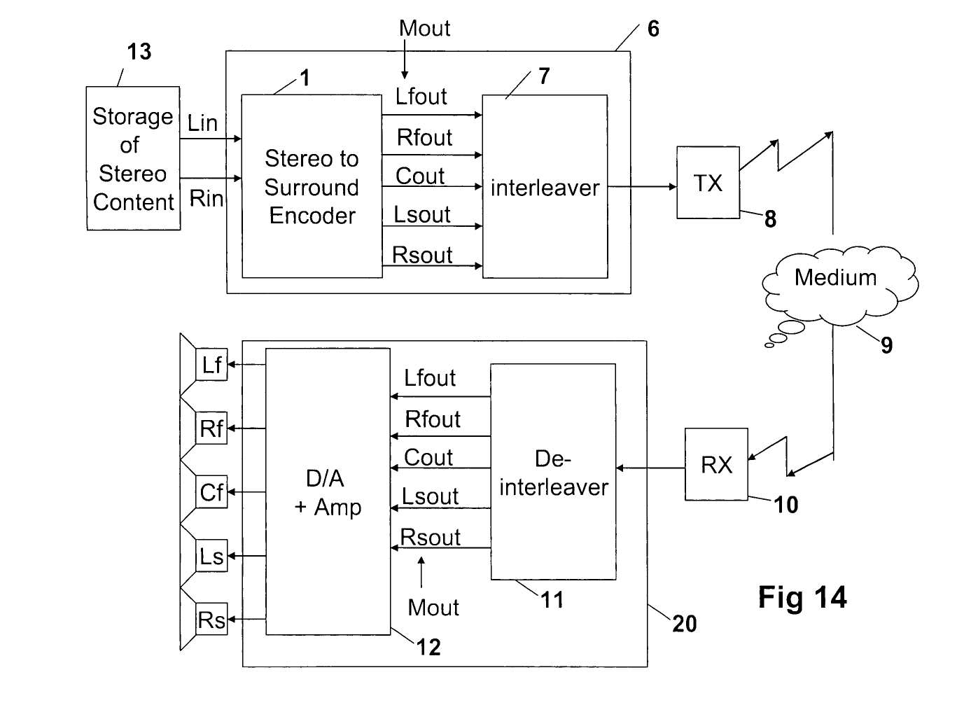

FIG. 14 shows a end-to-end broadcast system using the Stereo to Surround Encoder 1 of FIG. 7 or FIG. 13, wherein stereo content Lin, Rin is retrieved from a storage medium 13 (e.g. an audio-CD system, or CD-ROM or a hard-disk) and sent into an encoder 6 comprising a stereo to surround encoder system 1 such as e.g. shown in FIG. 7, and further comprising an interleaver 7 for combining the discrete signals Lfout, Rfout, Cout, Lsout and Rsout into a single data stream. The interleaved stream can then be transmitted by a transmitter 8 which may be part of the encoder 6, to a receiver 10 over a transmission medium 9, e.g. satellite, cable, internet, telephone, ADSL, etc. The receiver 10 sends the received stream to a decoder 20 comprising a de-interleaver 12 which de-interleaves the received stream and provides discrete audio channels to an amplifier which generates analog or digital audio signals for each speaker of the surround system. The decoder 20 may e.g. be an existing home theatre system or a set-top-box or a car system, etc.

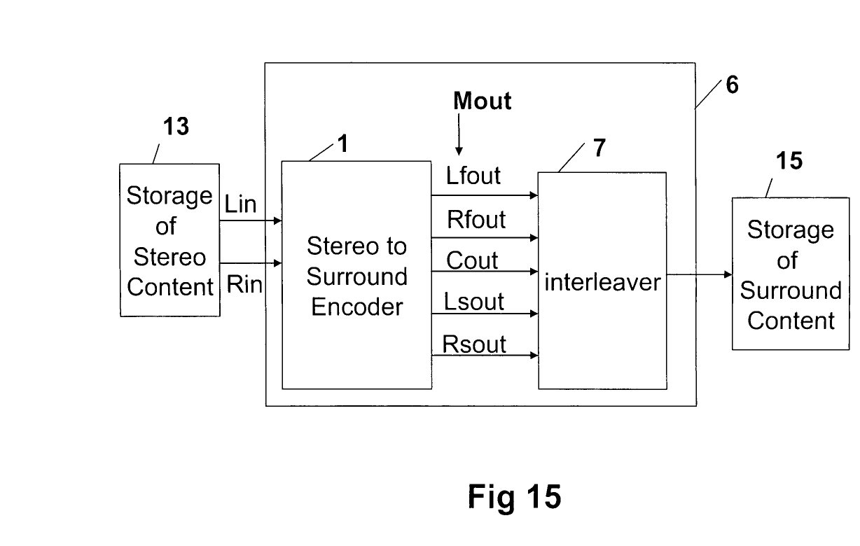

FIG. 15 shows another application whereby an archive of stereo content 13 is converted into an archive of surround content 15 using the encoder 6 explained in FIG. 14. As an example, an archive of audio-CDs with stereo content could be converted in this way into an archive of HD-DVD or Blu-Ray discs with surround content for a particular speaker configuration (e.g. 4.0, 5.0, 5.1 7.0, 7.1, etc). As explained above, this could be done in a fully automatic way, using a fixed set of optimized parameters per music genre, for generating surround files with a subjective quality rating of 8, which is already a major improvement over the prior art. Particular content providers (e.g. labels) could however also optimize the surround content to a subjective quality rating of 10, by involving a mastering engineer for fine-tuning the parameters, depending on the track being converted. Starting from the fixed optimised set of parameters for the specific genre, such fine-tuning can typically be done within a couple of minutes.

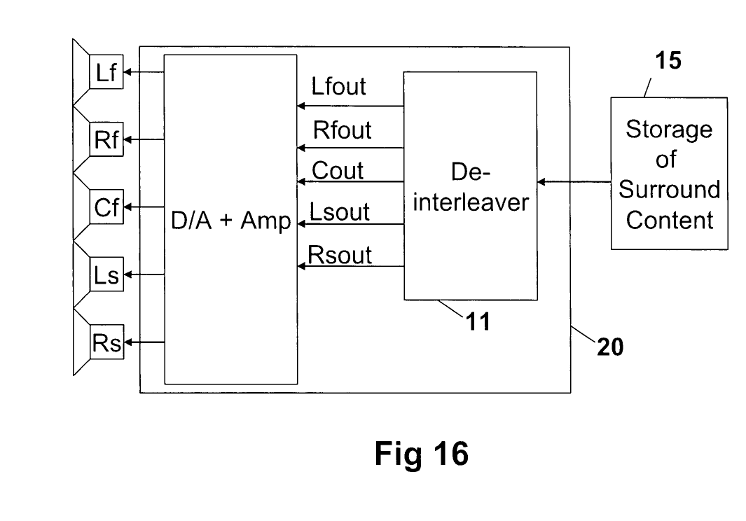

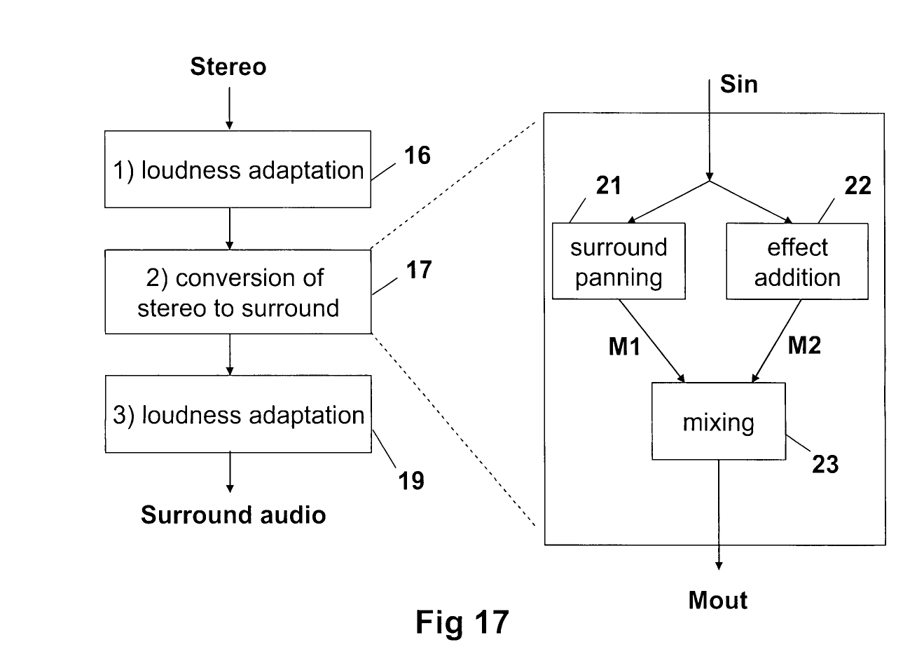

FIG. 16 shows an example of how the archive of surround content generated in FIG. 15, e.g. HD-DVD or Blu-Ray discs can then be played by end-users using existing decoders, such as e.g. existing HD-DVD or Blu-Ray players, or five speaker head phones (such as commercially available from e.g. Psyko Audio®, or home cinema systems, or surround-audio car systems, or other systems that are capable of playing such multi-channel audio streams known by the person skilled in the art.

Although the presented method is primarily focused at music without video, it should be noted that the method described above can also be used for re-authoring the audio content of videoclips and/or existing movies (such as e.g. stored on DVD or HD-DVD or Blu-Ray disks). In this case a stereo audio signal is first extracted from the storage medium (using decryption, de-compression, decoding etc), then the stereo audio signal is converted into a surround-channel audio signal Mout, and finally the surround-channel audio signal Mout is then re-encoded, encrypted etc synchronous with the video data and stored on a storage medium, e.g. a DVD, a HD-DVD, a Blu-Ray disk, a hard disk, a flash card, or any other storage medium known to the person skilled in the art. This may be particularly interesting for improving the surround audio content of existing video clips. Instead of storing the surround-channel audio signal Mout, it may also be streamed over a network, e.g. a cable network, satellite network, or any other network suitable for streaming this content.

### Detailed Example of an Embodiment

A detailed example of a method for converting a stereo audio file into a 5.1 audio file is described, whereby the 5.1 audio file comprising six discrete audio channels intended to be played on the six speakers of FIG. 4 or FIG. 6, is generated from a stereo audio file, e.g. a WAV file with left and right PCM samples of 16 bits each, sampled at 44.1 kHz. The music content may e.g. be pop, disco, oldies, classic, jazz, rock, reggae, or other kind of music genre. The stereo file may e.g. be derived from a red book audio CD, or from any other source.

In a first step 16, the loudness of the stereo audio file Sin is brought to a constant average loudness value (e.g. −12 dBfs), and the peak level is reduced to e.g. −0.5 dBfs to allow further processing without clipping. In this way all source material gets an average substantially constant dynamic range of approximately 11.5 dB. But other values for the dynamic range, e.g. in the range from 10.0 to 13.0 dB, preferably in the range from 11.0 dB to 12.0 dB, may also be used. And other values for the maximum peak level, e.g. values between −3.0 dB and −0.1 dB may also be used. This first step 16 may be implemented on a computer using professional audio mastering software, such as e.g. Wavelab® commercially available from the company Steinberg®. The first step is optional but very useful in order to normalize the input signals Sin before applying the processing of the second step 17. Tests have shown that by applying the first step 16 (leveling), a constant set of parameters (i.e. tools settings) can be used for all music content of a particular genre (e.g. pop music), as described above.

The second step 17 is the actual conversion of the stereo signal Sin to a surround audio signal Mout, and consists of three parts. In a first part 21 of the second step 17 the WAV file is converted into a first surround audio signal M1 with 6 channels Lf1, C1, Rf1, LFE1, Ls1, Rs1, wherein the total energy of the front channels Lf1, C1 and Rf1 (e.g. 55%) is chosen slightly higher than that of the total energy of the rear channels Ls1, Rs1 (e.g. 45%). In this example, an LFE channel is chosen having frequencies up to 51 Hz. It can be derived directly from the stereo input signal Sin, and its energy does not need to be taken into account in the surround panning step, because such low frequencies are hardly present in most music content. The first signal M1 may e.g. be generated in software, using the “Surround Mixer” from Nuendo/Steinberg, but other hardware or software tools known to the person skilled in the art may also be used, such as e.g. “Surround Panner” from Cubase, Pro Tools, Sequoia, Samplitude, and others. No substantial delay is added to the rear channels w.r.t. the front channels, in order to avoid the impression that all the music is coming from (i.e. the source is located at) the front speakers. In practice, the first multi-channel signal M1 may be converted into a “WAV file” with 24 bits/sample and a sampling rate of 48 kHz, but other sampling rates such as e.g. 96 kHz can also be used, to be compatible with existing playback devices. In a second part 22 of the second step 17, the WAV file is converted into a second surround audio signal M2 also having 6 channels (Lf2, C2, Rf2, LFE2, Ls2, Rs2) by a second tool, such as e.g. “UM226” commercially available from the company Waves®. This tool applies techniques such as up-mixing to convert the stereo information into six channels for creating audible effects, and adds a configurable amount of reverb. In a third part 23 of the second step 17, the corresponding channels of the first and second multi-channel signal M1 and M2 are mixed together with a weighting factor A=80% and B=20%. This may be implemented using a software program called Nuendo® (e.g. version 5), commercially available from the company Steinberg®. The three tools of the second step 17 are preferably executed simultaneously on a single computer.

In a third step 19, the loudness of the generated surround-channel audio signal Mout is conformed according to the latest EBU R128 loudness standard for surround audio content for adapting the dynamic range and for limiting the peaks. Alternatively, the dynamic range may be in the range from 10.0 to 13.0 dB, preferably in the range from 11.0 dB to 12.0 dB, most preferably substantially equal to 11.5 dB. And the maximum peak level may be a value between −3.0 dB and −0.1 dB, preferably substantially equal to −0.5 dB. This may be implemented using a tool called LevelOne®, commercially available from the company Grimmaudio®. Note that the method would also work without this third step 19, although it is clearly advantageous if all surround content would be conformed in a similar manner according to the same EBU loudness standard.

Although the method is primarily focused at music without video, it should be noted that the method described above may also be used for re-authoring the audio content of existing movies (as e.g. stored on DVD, HD-DVD or Blu-Ray disks). In this case a stereo audio signal is first extracted from the storage medium (using decryption, de-compression, decoding etc), then the stereo audio signal is converted into a surround-channel audio signal Mout according to the method described above, and finally the surround-channel audio signal Mout is re-encoded, encrypted etc synchronous with the video data and stored on a storage medium, e.g. a DVD, Blu-Ray disk, hard disk, or any other storage medium known to the person skilled in the art. This may be particularly interesting for improving the surround audio content of existing video clips.

Summarizing, the present invention provides a new method for generating a realistic surround sound image, in particular a 5.1 surround image from a stereo audio signal. The present invention provides a surround sound image that creates the impression that the listener is surrounded by the sound coming from all the speakers, the sound of each speaker having different effects.

1. A method for generating a surround-channel audio signal comprising at least two front signals and at least two rear signals from a source signal, the source signal being one of a mono audio signal comprising a single input signal and a stereo audio signal comprising a left and a right input signal, the method comprising the steps of:
a) generating a first multi-channel signal comprising left and right first front signals and left and right first rear signals by surround panning the source signal in such a way that the source signal is substantially equally spread over the first front and first rear signals;
b) generating a second multi-channel signal from the source signal comprising left and right second front signals and left and right second rear signals by effect processing the source signal so that the left and right second rear signals comprise at least reverberation of the source signal; and
c) mixing the corresponding signals of the first multi-channel signal and the second multi-channel signal in a predetermined ratio, wherein the first multi-channel signal is a main component and the second multi-channel signal is a secondary component.

2. The method according to claim 1, wherein the reverb has a noticeable duration of 1-30 ms.

3. The method according to claim 1, wherein the surround panning is applied such that 40-60% of the energy of the first multi-channel signal is located in the first rear signals.

4. The method according to claim 1, wherein the surround panning is achieved according to a matrix multiplication with real coefficients and the source signals.

5. The method according to claim 1, wherein the effect processing is achieved according to a matrix multiplication with complex coefficients having non-zero imaginary parts, and the source signals.

6. The method according to claim 1, wherein the mixing of the first and second multi-channel signal in step c) comprises 60-95% of the first multi-channel signal.

7. The method according to claim 1, wherein the surround-channel audio signal (Mout) is selected from the group consisting of: a 4.0 signal, a 5.0 signal, a 5.1 signal, a 7.0 signal and a 7.1 signal.

8. The method according to claim 1, wherein the method further comprises step d) preceding the steps a) and b), wherein the loudness of the source signal is adapted for obtaining a predefined dynamic range and peak level.

9. The method according to claim 8, wherein the dynamic range is a range from 10.0 to 13.0 dB.

10. The method according to claim 1, wherein the method further comprises step e) following step c) wherein the loudness of the surround-channel audio signal is adapted for obtaining a predefined dynamic range and maximum peak level.

11. The method according to claim 10, wherein the dynamic range is a range from 10.0 to 13.0 dB.

12. An electronic circuit for generating a multi-channel audio signal from a source signal, the source signal being one of a mono audio signal comprising a single input signal and a stereo audio signal comprising a left and a right input signal, the circuit comprising:
a) an input for receiving the source signal;
b) a surround panning module connected to the input for surround panning the source signal in such a way that the source signal is substantially equally spread over the first front and first rear signals;
c) an effect processor connected to the input for generating a second multi-channel audio signal derived from the source signal, the effect processor comprising a reverb filter used such that the left and right second rear signals comprise at least reverberation of the source signal; and
d) mixer elements for mixing the corresponding signals of the first multi-channel signal and the second multi-channel signal in a predetermined ratio, wherein the first multi-channel signal is a main component and the second multi-channel signal is a secondary component.

13. The electronic circuit according to claim 12, wherein the source signal is a stereo signal, and the surround panning module comprises a first and second attenuator for attenuating the left input signal into a left front and rear signal, and a third and fourth attenuator for attenuating the right input signal into a right front and rear signal.

14. The electronic circuit according to claim 12, wherein each mixer element comprises a first scaler for scaling a signal of the first multi-channel audio signal, and a second scaler for scaling the corresponding signal of the second multi-channel audio signal and an adder for adding the outputs of the first scaler and the second scaler.

15. A computer program product on a non-transient computer medium which is directly loadable into the internal memory of the digital computer system, comprising software code fragments for generating a surround-channel audio signal comprising at least two front signals and at least two rear signals from a source signal, the source signal being one of a mono audio signal comprising a single input signal and a stereo audio signal comprising a left and a right input signal, by executing the following steps:
a) generating a first multi-channel signal comprising left and right first front signals and left and right first rear signals by surround panning the source signal in such a way that the source signal is substantially equally spread over the first front and first rear signals;
b) generating a second multi-channel signal from the source signal comprising left and right second front signals and left and right second rear signals by effect processing the source signal so that the left and right second rear signals comprise at least reverberation of the source signal; and
c) mixing the corresponding signals, of the first multi-channel signal and the second multi-channel signal in a predetermined ratio, wherein the first multi-channel signal is a main component and the second multi-channel signal is a secondary component.

16. The method according to claim 1, wherein the surround panning is applied such that 45-55% of the energy of the first multi-channel signal is located in the first rear signals.

17. The method according to claim 1, wherein the surround panning is applied such that 45-50% of the energy of the first multi-channel signal is located in the first rear signals.

18. The method according to claim 1, wherein the mixing of the first and second multi-channel signal in step c) comprises 70-90% of the first multi-channel signal.

19. The method according to claim 1, wherein the mixing of the first and second multi-channel signal in step c) comprises approximately 80% of the first multi-channel signal.

20. The method according to claim 8, wherein the dynamic range is a range from 11.0 dB to 12.0 dB.

21. The method according to claim 8, wherein the maximum peak level is a value between −3.0 dB and −0.1 dB.

22. The method according to claim 8, wherein the maximum peak level is a value substantially equal to −0.5 dB.

23. The method according to claim 10, wherein the dynamic range is a range from 11.0 dB to 12.0 dB.

24. The method according to claim 10, wherein the maximum peak level is a value between −3.0 dB and −0.1 dB.

25. The method according to claim 10, wherein the maximum peak level is a value substantially equal to −0.5 dB.
